(19) United States
(12) Patent Application Publication
(10) Pub. No.: US 2024/0034931 A1
(43) Pub. Date: Feb. 1, 2024

(54) QUANTUM DOT COMPOSITION, AND QUANTUM DOT FILM AND DISPLAY DEVICE USING THE SAME

(71) Applicants: LG Display Co., Ltd., Seoul (KR); DCT Co.,Ltd, Chilgok-gun Gyeongsangbuk-do (KR)

(72) Inventors: YongHun Jeong, Seoul (KR); ByungHyuck Seo, Paju-si (KR); DoEok Kim, Daegu (KR); JeongHwan Yu, Daegu (KR); Haesik Kim, Daegu (KR); HanIl Chung, Daegu (KR); HyunJi Yun, Daegu (KR)

(21) Appl. No.: 18/226,133

(22) Filed: Jul. 25, 2023

(30) Foreign Application Priority Data
Jul. 26, 2022 (KR) 10-2022-0092752

(51) Int. Cl. C09K 11/70; C08F 20/06; G02F 1/017

(52) U.S. Cl. CPC C09K 11/703; C08F 20/06; G02F 1/01791

(57) ABSTRACT

A quantum dot composition, and a quantum dot film and a display device using the same is described. More particularly, a quantum dot composition includes a first quantum dot and a second quantum dot having different maximum emission wavelengths, a light absorber having a main absorption wavelength of 570 nm to 600 nm, and an oligomer. According to the present disclosure, when the film formed of the quantum dot composition of the present disclosure is applied as an optical film of a display device, color purity is improved and thus, high color reproduction can be implemented.

### CROSS-REFERENCE TO RELATED APPLICATIONS

This application claims the benefit of and priority to Republic of Korea Patent Application No. 10-2022-0092752 filed on Jul. 26, 2022 in the Republic of Korea, the entire contents of which are hereby expressly incorporated by reference into the present application.

### BACKGROUND

### Technical Field

The present disclosure relates to a quantum dot composition, and a quantum dot film and a display device using the same, and more particularly, to a quantum dot composition capable of improving color reproducibility with an improvement in color purity while maintaining high optical properties and having high thermal stability, and a quantum dot film and a display device using the same.

### Discussion of the Related Art

Quantum dots are semiconductor materials with a nano-sized crystal structure, and are materials with high color purity, excellent light stability and thermal stability compared to organic materials, and easiness of bandgap control.

Since these quantum dots are small in size, have a large surface area per unit volume, and exhibit a quantum confinement effect, they have physical and chemical properties different from those of the semiconductor material itself. The quantum dots absorb light from an excitation source to enter an energy excited state, and emit energy corresponding to an energy bandgap of the quantum dots. Since quantum dots can allow for energy bandgap control by controlling sizes and compositions of nanocrystals and have light emitting characteristics with high color purity, the development of various applications such as display devices, energy devices, or bioluminescent devices is being conducted.

For example, a quantum dot composition or a quantum dot film may be used as an optical film for improving optical properties of a liquid crystal display device. Specifically, when a quantum dot film is disposed on an LED light source emitting blue light, white light having high luminance and luminous efficiency is transmitted to a liquid crystal panel, so that optical characteristics of the display device can be improved. Recently, demand for full color implementation and implementation of color close to natural light is increasing, and in response to this, technology development for display devices having color reproducibility of 90% or more according to BT.2020 (or Rec.2020) (CIE 1976 standard) is needed.

### SUMMARY

Accordingly, an aspect of the present disclosure is to provide a quantum dot composition capable of implementing high color reproduction with improved color purity when applied to an optical film of a display device, and a quantum dot film and a display device using the same.

In addition, another aspect of the present disclosure is to provide a quantum dot composition and a quantum dot film having excellent optical properties by including quantum dots having excellent quantum efficiency and excellent light stability and thermal stability.

Objects of the present disclosure are not limited to the above-mentioned objects, and other objects, which are not mentioned above, can be clearly understood by those skilled in the art from the following descriptions.

A quantum dot composition according to an exemplary embodiment of the present disclosure includes a first quantum dot and a second quantum dot having different maximum emission wavelengths, a light absorber having a main absorption wavelength of 570 nm to 600 nm, and an oligomer.

In addition, a quantum dot film according to an exemplary embodiment of the present disclosure includes a cured product of the quantum dot composition.

In addition, a display device according to an exemplary embodiment of the present disclosure includes a backlight unit; a quantum dot optical film disposed on the backlight unit and including a first quantum dot and a second quantum dot having different maximum emission wavelengths, a light absorber having a main absorption wavelength of 570 nm to 600 nm, and a resin; and a display panel disposed on the quantum dot optical film.

Other detailed matters of the exemplary embodiments are included in the detailed description and the drawings.

According to the present disclosure, a quantum dot composition includes two types of quantum dots having different emission wavelengths, a light absorber having an absorption wavelength of 570 nm to 600 nm, and an oligomer, and may be used as an ink for a display device. In addition, the composition can be cured to form a film and used as an optical film for a display device.

According to the present disclosure, when the film formed of the quantum dot composition of the present disclosure is applied as an optical film of a display device, color purity is improved and thus, high color reproduction can be implemented.

According to the present disclosure, a quantum dot composition of the present disclosure includes quantum dots having excellent quantum efficiency and excellent light stability and thermal stability, so that optical properties of a display device can be improved.

The effects according to the present disclosure are not limited to the contents exemplified above, and more various effects are included in the present specification.

### BRIEF DESCRIPTION OF THE DRAWINGS

FIG. 1 is a schematic cross-sectional view of a display device according to an exemplary embodiment of the present disclosure.

FIG. 2 shows emission spectra of quantum dot optical films according to Example 2, Comparative Example 1, and Comparative Example 2 of the present disclosure.

### DETAILED DESCRIPTION OF THE EMBODIMENTS

Advantages and characteristics of the present disclosure and a method of achieving the advantages and characteristics will be clear by referring to exemplary embodiments described below in detail together with the accompanying drawings. However, the present disclosure is not limited to the exemplary embodiments disclosed herein but will be implemented in various forms. The exemplary embodiments are provided by way of example only so that those skilled in the art can fully understand the disclosures of the present disclosure and the scope of the present disclosure.

The shapes, sizes, ratios, angles, numbers, and the like illustrated in the accompanying drawings for describing the exemplary embodiments of the present disclosure are merely examples, and the present disclosure is not limited thereto.

Like reference numerals generally denote like elements throughout the specification. Further, in the following description of the present disclosure, a detailed explanation of known related technologies may be omitted to avoid unnecessarily obscuring the subject matter of the present disclosure. The terms such as “including,” “having,” and “consist of” used herein are generally intended to allow other components to be added unless the terms are used with the term “only”. Any references to singular may include plural unless expressly stated otherwise.

Components are interpreted to include an ordinary error range even if not expressly stated.

When the position relation between two parts is described using the terms such as “on”, “above”, “below”, and “next”, one or more parts may be positioned between the two parts unless the terms are used with the term “immediately” or “directly”.

When an element or layer is disposed “on” another element or layer, another layer or another element may be interposed directly on the other element or therebetween.

Although the terms “first”, “second”, and the like are used for describing various components, these components are not confined by these terms. These terms are merely used for distinguishing one component from the other components. Therefore, a first component to be mentioned below may be a second component in a technical concept of the present disclosure.

Like reference numerals generally denote like elements throughout the specification.

A size and a thickness of each component illustrated in the drawing are illustrated for convenience of description, and the present disclosure is not limited to the size and the thickness of the component illustrated.

The features of various embodiments of the present disclosure can be partially or entirely adhered to or combined with each other and can be interlocked and operated in technically various ways, and the embodiments can be carried out independently of or in association with each other.

A quantum dot composition according to an exemplary embodiment of the present disclosure may include first quantum dots, second quantum dots, light absorbers, scattering agents, oligomers, and monomers. The first quantum dots, the second quantum dots, the light absorbers and the scattering agents exist in a uniformly dispersed state on the oligomers and monomers. The quantum dot composition includes first and second quantum dots emitting light of specific wavelengths and light absorbers absorbing light of a specific wavelength range and may be applied to a display device and the like to improve optical properties. For example, the quantum dot composition may be used as an ink for a display device for forming a wavelength converter, an optical film, a color filter, and the like of the display device.

The oligomers and monomers included in the quantum dot composition are cured by heat or light irradiated from the outside to form a resin. Accordingly, the quantum dot composition may be prepared in the form of a film.

Specifically, quantum dot films of various types can be easily prepared by forming a quantum dot composition into a film on a substrate and then curing it by applying heat or irradiating light. The quantum dot film thus prepared may be used as an optical film of a display device to improve optical characteristics of the display device.

Hereinafter, with reference to the drawings, a quantum dot optical film formed of a quantum dot composition and a display device including the same according to an exemplary embodiment of the present disclosure will be described in detail.

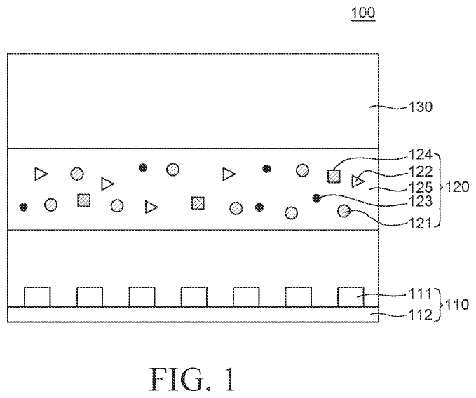

FIG. 1 is a schematic cross-sectional view of a display device according to an exemplary embodiment of the present disclosure.

Referring to FIG. 1, a display device 100 according to an exemplary embodiment of the present disclosure includes a backlight unit 110, a quantum dot optical film 120, and a display panel 130.

The display panel 130 is a panel that displays an image. For example, the display panel 130 may be a liquid crystal display panel. The liquid crystal display panel displays an image by controlling light transmittance while changing arrangements of liquid crystals included in a liquid crystal layer of the display panel 130 by light irradiated from the backlight unit 110 to the display panel 130.

The backlight unit 110 supplies light to the display panel 130. The backlight unit 110 may include a plurality of light sources 111, a printed circuit board, and a reflector 112. The backlight unit 110 may be implemented as a direct light type of irradiating light from the plurality of light sources 111 installed directly under the display panel 130 to the display panel 130 and an edge light type of transmitting light from the plurality of light sources 111 installed on a sidewall of a light guide panel to the display panel 130, according to an arrangement shape of the light sources 111.

The printed circuit board is electrically connected to each of the plurality of light sources 111 and applies a voltage to each light source 111.

The reflector 112 reflects light traveling from the light source 111 rearward or laterally of the light source 111 without being directed in a front thereof where the display panel 130 is disposed, in the front, thereby improving luminance of light incident on the display panel 130.

The light source 111 emits light when a voltage is applied from the printed circuit board. For example, each of the plurality of light sources 111 may be a light emitting diode (LED). The light sources 111 emit light of various colors depending on types thereof. Specifically, the light sources 111 include a red light source emitting red light, a green light source emitting green light, a blue light source emitting blue light, and a white light source emitting white light. For example, each of the plurality of light sources 111 may be a blue LED emitting blue light. Specifically, the blue LED may emit blue light having a wavelength of 430 nm to 450 nm. In this case, luminous efficiency and luminance of the backlight unit 110 are excellent.

The quantum dot optical film 120 is disposed between the backlight unit 110 and the display panel 130. The quantum dot optical film 120 converts blue light emitted from the backlight unit 110 into white light. In this manner, when the quantum dot optical film 120 is used, light having higher luminous efficiency and luminance and excellent color purity may be incident to the display panel 130, compared to a case of using a light source emitting white light. Accordingly, color reproducibility of the display device 100 can be improved.

The quantum dot optical film 120 may include first quantum dots 121, second quantum dots 122, light absorbers 123, scattering agents 124, and a resin 125. Hereinafter, respective elements are described in detail.

The first quantum dots 121 and the second quantum dots 122 may have different maximum emission wavelengths. For example, a maximum emission wavelength of the first quantum dots 121 may be 500 nm to 540 nm or 500 nm to 520 nm, and a maximum emission wavelength of the second quantum dots 122 may be 610 nm to 650 nm or 630 nm to 650 nm. The first quantum dot 121 may be a quantum dot emitting green light, and the second quantum dot 122 may be a quantum dot emitting red light. In the case of including the first quantum dots 121 and the second quantum dots 122 having such characteristics, the blue light emitted from the light source 111 can be converted into white light of high purity. Furthermore, there are effects in that color purity and color reproducibility of the display device 100 are improved while luminous efficiency and luminance of the display device 100 are excellent.

For example, each of the first quantum dots 121 and the second quantum dots 122 may include one or more first metals selected from among Cd, Zn, In, Mg, Mn, Cu, Ga, Al, Sr, Ba, Fe, and Sn, and two or more second metals selected from among Se, S, P, Te, As, N, and Sb.

Each of the first quantum dots 121 and the second quantum dots 122 may have a core-shell structure. In this case, when each of a core and a shell includes a ternary or more metal, the ternary or more metal may be formed in an alloy form. For example, each of the first quantum dots 121 and the second quantum dots 122 may be composed of an alloy-type core and an alloy-type shell. When the core and the shell are configured as an alloy form, a mismatch in lattice constant mismatch is minimized, thereby providing excellent optical durability of the quantum dots.

Specifically, for example, the first quantum dot 121 may include a core composed of In—Zn—P and a shell composed of Zn—Se—S, and the second quantum dot 122 may include a core composed of In—P and a shell composed of Zn—Se—S. In this case, optical durability and thermal stability of the quantum dots are excellent, while luminous efficiency is high.

As described above, in order to convert blue light emitted from the light source 111 into white light of high purity, emission wavelengths of the first quantum dots 121 and the second quantum dots 122 need to be adjusted within a specific range. Hereinafter, a method of preparing the first quantum dots 121 and the second quantum dots 122 will be described.

Hereinafter, for convenience of description, it is specified that the first quantum dot 121 includes a core composed of In—Zn—P and a shell composed of Zn—Se—S, and the second quantum dot 122 includes a core composed of In—P and a shell composed of Zn—Se—S, but this is an exemplary embodiment and the present disclosure is not limited thereto.

First, the core of the first quantum dot 121 may be formed through a process of heating a first mixture including a first cation precursor including an indium oxo cluster (In-Oxocluster) and a zinc oxo cluster (Zn-Oxocluster) and a first anion precursor including phosphorus (P) to a high temperature of 300° C. to 350° C.

In this manner, when the indium oxo cluster and the zinc oxo cluster are used as the cation precursor, a quantum dot core having a more uniform composition can be formed, and the quantum dots have excellent optical durability.

A wavelength range of the quantum dots may be controlled by adjusting a ratio of the indium oxo cluster to the zinc oxo cluster included in the first mixture. For example, a molar ratio of the indium oxo cluster to the zinc oxo cluster may be 1:1 to 1:0.4. More specifically, for example, the molar ratio of the indium oxo cluster to the zinc oxo cluster may be 1.2:1.2 to 1.8:0.8 based on that the anion precursor, for example, phosphorus (P) is 1. In this case, a full width at half maximum (FWHM) of the quantum dot is narrow and quantum efficiency is excellent.

For example, high temperature heating may be performed within 120 seconds, preferably within 60 seconds, and may be performed at a rate of 3° C. to 10° C. per second. The core of the first quantum dot 121 prepared as described above has a uniform particle diameter distribution, a narrow full width at half maximum (FWHM), and excellent quantum efficiency.

High-rate heating may be referred to as rapid thermal processing (RTP). High-rate heating may be performed using a rapid heating device. For example, the first mixture may be rapidly heated using radiant heat generated from a lamp. In this case, the temperature of the first mixture may be rapidly increased using a halogen lamp, a tungsten-halogen lamp, or a xenon arc lamp.

A step of heat-treating the first mixture at 300° C. or more for 1 second to 10 seconds to adjust sizes of the quantum dots after the high-rate heating may be further included.

In addition, a step of performing additional heat-treating at 300° C. or more for 10 seconds or more by mixing trioctylphosphine in the heat-treated first mixture may be further included. In this case, surface reactivity of the core is improved to facilitate shell formation.

Next, the shell of the first quantum dot 121 may be formed through a process of preparing a second mixture by mixing a second cation precursor including zinc oleate and a second anion precursor including trioctylphosphine selenide and trioctylphosphine sulfide in a solution including the core of the first quantum dot 121 prepared as described above and heating the second mixture to 350° C. to 400° C. at a high rate. In this case, a time, speed and device for high-rate heating are identical to those described with regard to a process of preparing the core of the first quantum dot 121.

Zinc oleate is prepared by reacting zinc with oleic acid. In this case, the wavelength range of the quantum dots may be controlled by adjusting a molar ratio of zinc to oleic acid. For example, the molar ratio of zinc to oleic acid may be 1:1.3 to 1:1.7, preferably 1:1.5.

In addition, a ratio of trioctylphosphine selenide and trioctylphosphine sulfide may be adjusted to control the wavelength range of the quantum dots. For example, a molar ratio of sulfur to selenium may be 0.8:1 to 1:2.5, preferably 0.8:1 to 1:1.8. Preferably, when the shell of the first quantum dot is prepared, the molar ratio of sulfur to selenium may be 1:1 to 1:2.5, preferably 1:1 to 1:1.7. Within this range, the quantum dots emit light in a desired wavelength range, while having a narrow full width at half maximum (FWHM) and allowing for excellent luminous efficiency.

The maximum emission wavelength of the first quantum dots 121 prepared as described above may be 500 nm to 540 nm. More preferably, the first quantum dots 121 prepared by the above-described preparing method may be green light emitting quantum dots having a maximum emission wavelength of 520 nm or less, which is small, compared to quantum dots manufactured by a conventional preparing method. In this case, blue light emitted from the light source 111 may be converted into white light of higher purity while maintaining high luminance.

The core of the second quantum dot 122 may be performed in the same manner as a process of preparing the core of the first quantum dot 121 except for the use of the first cation precursor including an indium oxo cluster (In-Oxocluster). Accordingly, a redundant description will be omitted.

In the case of the second quantum dots 122, the wavelength range of the quantum dots may be controlled by adjusting a molar ratio of the indium oxo cluster and phosphorus (P) which is the first anion precursor, included in the first mixture. For example, the molar ratio of the indium oxo cluster to phosphorus (P) may be 1:1 to 1.5:1. In this case, the quantum dots emit light in a desired wavelength range, while a full width at half maximum (FWHM) thereof is narrow and luminous efficiency is excellent.

A step of preparing the shell of the second quantum dot 122 may be performed in the same manner as the step of preparing the shell of the first quantum dot 121. Accordingly, a redundant description will be omitted. When the shell of the second quantum dot is prepared, the molar ratio of sulfur to selenium may be 0.8:1 to 1:2.5, preferably 0.8:1 to 0.8:1.5. Within this range, the quantum dots emit light in a desired wavelength range, while the full width at half maximum (FWHM) is narrow and luminous efficiency is excellent.

The maximum emission wavelength of the second quantum dots 122 prepared as described above may be 610 nm to 650 nm. More preferably, the second quantum dots 122 manufactured by the above-described preparing method may be red light emitting quantum dots having a maximum emission wavelength of 630 nm or more, which is large, compared to quantum dots manufactured by a conventional preparing method. Accordingly, blue light emitted from the light source 111 may be converted into white light of higher purity while maintaining high luminance.

The light absorber 123 improves color reproducibility of the display device 100 by further improving color purity of the first quantum dots 121 and the second quantum dots 122. The light absorber 123 may have a very low absorption rate for blue light having a wavelength of 430 nm to 450 nm, and may have a main absorption wavelength of 550 nm to 620 nm, preferably 570 nm to 600 nm, and more preferably 580 nm to 590 nm. In this case, the light absorber 123 transmits the blue light emitted from the light source 111 well to maintain high luminance and luminous efficiency, and at the same time, the light absorber 123 absorbs yellow light having a wavelength between the maximum emission wavelengths of the first quantum dots 121 and the second quantum dots 122 to improve color purity and color reproducibility. When the main absorption wavelength of the light absorber 123 is out of the above range, luminance of the display device 100 may decrease.

As the light absorber 123, an organic material or inorganic material in which the main absorption wavelength is within the range, thermal stability and light stability are excellent, and dispersion in the resin 125 is facilitated may be used. For example, the light absorber 123 may be a dye having a main absorption wavelength of 570 nm to 600 nm or 580 nm to 590 nm. Specifically, for example, the light absorber 123 may be a tetraaza porphyrin-based, rhodamine-based, squaraine-based, or cyanine-based material, but is not limited thereto.

The light absorber 123 may be included in the quantum dot optical film 120 at a concentration of 10 ppm to 100 ppm, preferably 30 ppm to 80 ppm. Within this range, color purity and color reproducibility may be improved by narrowing the full width at half maximum of each of the first quantum dots 121 and the second quantum dots 122 while maintaining high luminance. For example, when the quantum dot optical film 120 according to the present disclosure is included, a high color reproducibility of 90% or more according to BT.2020 (CIE 1976 standard) can be achieved. When the concentration of the light absorber 123 is less than 30 ppm, the color reproducibility is less than 90%, and an improvement effect is insignificant. When the concentration of the light absorber 123 exceeds 100 ppm, luminance may decrease and luminous efficiency may decrease.

The quantum dot optical film 120 may optionally include the scattering agents 124 as needed. The scattering agent 124 allows light incident into the quantum dot optical film 120 and light emitted from the quantum dots to be dispersed in various directions. Accordingly, an optical path of light is increased, light loss is reduced, and thus, luminous efficiency can be improved.

For example, the scattering agent 124 may be one or more selected from TiO₂, ZnO, ZrO₂, SiO₂ and BaSO₄, but is not limited thereto. For example, the scattering agent 124 may have a spherical shape, but is not limited thereto.

The resin 125 allows the first quantum dots 121, the second quantum dots 122, the light absorbers 123, and the scattering agents 124 to be uniformly dispersed, and fixes the materials into the quantum dot optical film 120. In addition, the resin 125 protects the quantum dots from external impacts or environments. In addition, the resin 125 retards permeation of oxygen or moisture from the outside to suppress deterioration of the quantum dots by oxygen or moisture.

As described above, the quantum dot optical film 120 is formed by curing the quantum dot composition. The quantum dot composition includes oligomers and monomers. After forming the quantum dot composition into a film, when heat is applied or light is irradiated thereon, the oligomers and monomers are cured to form the resin 125.

For example, the oligomers may be acrylate-based oligomers, and the monomers may be acrylate-based monomers. These oligomers and monomers are cured to form an acrylic resin.

Specifically, the acrylate oligomers may be one or more selected from among (meth)acrylate oligomers, urethane (meth)acrylate oligomers, epoxy (meth)acrylate oligomers, polyester (meth)acrylates, polyether (meth)acrylates, and the like, but the present disclosure is not limited thereto.

Specifically, for example, the acrylate-based monomers may be one or more selected from among isobornyl (meth)acrylate, isooctyl (meth)acrylate, lauryl (meth)acrylate, benzyl (meth)acrylate, isononyl (meth)acrylate, isodecyl (meth)acrylate, cyclohexyl (meth)acrylate, n-hexyl (meth)acrylate, adamantyl acrylate, and cyclopentyl acrylate, but the present disclosure is not limited thereto.

Preferably, the monomer may be isobornyl (meth)acrylate. This has advantages capable of uniformly dispersing the first quantum dots 121, the second quantum dots 122, and the light absorbers 123 because of its low viscosity and being thermally stable. Specifically, isobornyl (meth)acrylate can form an acrylic resin having a high glass transition temperature when cured by including a bicyclic structure in molecules. In addition, isobornyl (meth)acrylate minimizes a crosslinking reaction during curing to form an acrylic resin that is thermally stable and has excellent mechanical properties such as hardness, elasticity, flexibility, and impact resistance and excellent adhesiveness.

The quantum dot composition may further include an initiator capable of forming reactive radicals by application of heat or light to facilitate curing of the oligomers and monomers. For example, the initiator may be a benzoin-based, hydroxy ketone-based, or phosphine oxide-based material, but the present disclosure is not limited thereto.

The quantum dot composition may be prepared by putting and mixing the first quantum dots 121, the second quantum dots 122, the light absorbers 123, the scattering agents 124, the oligomers, and the monomer in a batch. As another example, a first quantum dot dispersion solution is prepared by dispersing the first quantum dots 121 in monomers having a low viscosity, a second quantum dot dispersion solution is prepared by dispersing the second quantum dots 122 in monomers, and a light absorber dispersion solution is prepared by dispersing the light absorbers 123 in monomers, respectively. Then, a quantum dot composition can be prepared by mixing the first quantum dot dispersion solution, the second quantum dot dispersion solution, and the light absorber dispersion solution. In this case, the first quantum dot 121, the second quantum dot 122, and the light absorber 123 are more uniformly dispersed in the quantum dot composition to form the quantum dot optical film 120 having uniform physical properties.

According to an exemplary embodiment of the present disclosure, the quantum dot optical film 120 that is formed by forming the quantum dot composition including the first quantum dots 121 and the second quantum dots 122 having different maximum emission wavelengths, the light absorbers 123 having a main absorption wavelength of 570 nm to 600 nm, the scattering agents 124, the oligomers, and monomers into a film and then, curing it, is disposed between the backlight unit 110 and the display panel 130, so that full widths at half maximum of the first and second quantum dots 121 and 122 are narrow and color purity is improved while high luminance is maintained. Accordingly, the display device 100 according to the present disclosure can achieve a color reproducibility of 90% or more, which is high, according to BT.2020 (CIE 1976 standard).

Hereinafter, effects of the present disclosure described above will be described in more detail through Examples and Comparative Examples. However, the following examples are for illustration of the present disclosure, and the scope of the present disclosure is not limited by the following examples.

### Example 1

### (1) Synthesis of First Quantum Dots

(1-1) Synthesis of Indium Oxo Cluster (in-Oxo Cluster)

First, after indium acetate (Indium (III) acetate) 63 g (216.0 mmol) and oleic acid 183 g (648.0 mmol) were mixed in a 2 L container and heated to 200° C. under vacuum, pressure thereof was converted to normal pressure, octadecene (ODE) was added therein, and they were synthesized at 260° C. to 300° C. for 1 hour or more. Thus, an indium oxo cluster was prepared.

(1-2) Synthesis of Zn-Oxo Cluster

After zinc acetate dihydrate 47 g (216.0 mmol) and oleic acid 122 g (432.0 mmol) were mixed in a 1 L container and heated to 190° C. under vacuum, pressure thereof was converted to normal pressure, octadecene (ODE) was added therein, and they were synthesized at 300° C. to 315° C. for 1 hour or more. Thus, a zinc oxo cluster was prepared.

(1-3) Core Synthesis of First Quantum Dots

After an In-Oxo cluster solution 160 g (46.0 mmol) and a Zn-Oxo cluster solution 57.6 g (30.5 mmol) prepared were mixed in a 1 L quartz container, and heated to 100° C. under a N₂ atmosphere, 48 g (38.4 mmol) of TMSP (Tris (trimethylsilyl) phosphine) (20 wt % in TOP), which is a first anion precursor, was added therein. Accordingly, a first mixture was prepared. In this case, a molar ratio of indium (In):zinc (Zn):phosphorus (P) in the first mixture is 1.2:0.8:1.

The first mixture was rapidly heated to 300° C. by raising temperature at a rate of about 200° C. per minute using radiant heat, and then reacted for 1 second to 10 seconds while maintaining the same reaction temperature. Thereafter, the first mixture was rapidly cooled to 100° C. or less within 1 minute, so that a core solution was prepared. It was confirmed that a wavelength of first quantum dot cores prepared in this manner was 436 nm, and a P/V (Peak to Valley) value was 0.56.

(1-4) Synthesis of Zinc Oleate (Zn-OA)

After zinc acetate dihydrate 2063 g (9396.0 mmol) and oleic acid 3981 g (14094.0 mmol) were mixed in a 20 L container, heated and stirred under vacuum to 190° C., trioctylamine (TOA) 3608 g was added therein, and they were heated to 260° C. and then, cooled. Accordingly, zinc oleate (Zn-OA), which is a second cation precursor, was prepared. In this case, a molar ratio of zinc (Zn):oleic acid (OA) of zinc oleate (Zn-OA) was 1:1.5.

(1-5) Synthesis of Trioctylphosphine Selenide (Se-TOP)

Selenium (Se) powder 948 g (12000.0 mmol) and trioctylphosphine (TOP) 5485 g (6.6 L) were mixed in a 10 L container, heated to 250° C. under vacuum and N₂ atmosphere, stirred until they were completely dissolved, and then, cooled. Thus, a second anion precursor, trioctylphosphine selenide (Se-TOP) was prepared.

(1-6) Synthesis of Trioctylphosphine Sulfide (S-TOP)

Sulfur (S) powder 769.68 g (24000.0 mmol) and trioctylphosphine (TOP) 10637 g (12.8 L) were mixed in a 30 L container, heated to 150° C. under vacuum and N₂ atmosphere, stirred until they were completely dissolved, and then, cooled. Thus, a second anion precursor, trioctylphosphine sulfide (S-TOP), was prepared.

(1-7) Shell Synthesis of First Quantum Dots

Zinc oleate (Zn-OA) 273 g (Zn: 313.2 mmol), in which zinc (Zn):oleic acid (OA) is 1:1.5 and trioctylphosphine (TOP) 4 g were mixed with the core solution prepared above (In:Zn:P=1.2:0.8:1, A=436 nm) 26.6 g, in a 1 L quartz container and, they were stirred. Thereafter, the previously prepared trioctylphosphine selenide (Se-TOP) 21 g (39.1 mmol) and trioctylphosphine sulfide (S-TOP) 27 g (56.7 mmol) were added thereto at 20° C. to 24° C. to prepare a second mixture.

The second mixture was rapidly heated to 370° C. by raising temperature at a rate of about 200° C. per minute using radiant heat, and then reacted for 30 seconds to 5 minutes while maintaining a temperature of 350° C. to 370° C. Thereafter, the second mixture was rapidly cooled to 100° C. or less within 1 minute to obtain first quantum dots having a ZnSeS shell formed on an InZnP core surface. It was confirmed that a maximum emission peak of the first quantum dots prepared as described above was 518 nm, a full width at half maximum thereof was 35 nm, and quantum efficiency was 91%.

(2) Synthesis of Second Quantum Dots

(2-1) Core Synthesis of Second Quantum Dots

A first mixture was prepared by putting the prepared In-Oxo cluster solution 200 g (57.6 mmol) into a 1 L quartz container and adding TMSP (20 wt % in TOP) 48 g (38.4 mmol) at 130° C. At this time, a molar ratio of indium (In):phosphorus (P) in the first mixture was 1.5:1.

The first mixture was rapidly heated to 300° C. by raising temperature at a rate of about 200° C. per minute using radiant heat, and then reacted within 10 seconds while maintaining the same reaction temperature. The first mixture was then rapidly cooled to prepare a core solution.

In-Oxo cluster solution 100 g (28.8 mmol) and TMSP (20% in TOP) 36 g (28.8 mmol) were additionally added in the previously prepared core solution, and they were rapidly heated to 300° C. by raising temperature at a rate of about 200° C. per minute using radiant heat and then, were reacted within 10 seconds while maintaining the same reaction temperature, and rapidly cooled. This same process was additionally performed twice.

In-Oxo cluster solution 50 g (14.4 mmol) and TMSP (20% in TOP) 18 g (14.4 mmol) were additionally added in the previously prepared core solution, and they were rapidly heated to 300° C. by raising temperature at a rate of about 200° C. per minute using radiant heat and then, were reacted within 10 seconds while maintaining the same reaction temperature, and rapidly cooled. The same process was additionally performed one more time to synthesize a second quantum dot core. It was confirmed that a wavelength of second quantum dot cores prepared in this manner was 589 nm, and a P/V (Peak to Valley) value was 0.57.

(2-2) Shell Synthesis of Second Quantum Dots

Zinc oleate (Zn-OA) 273 g (Zn: 313.2 mmol), in which zinc (Zn):oleic acid (OA) is 1:1.5, and trioctylphosphine (TOP) 4 g were mixed with the core solution of the second quantum dot prepared above (2=589 nm) 36 g, and they were stirred. Thereafter, the previously prepared trioctylphosphine selenide (Se-TOP) 20 g (37.3 mmol) and trioctylphosphine sulfide (S-TOP) 16 g (33.6 mmol) were added thereto at 20° C. to 24° C. to prepare a second mixture.

The second mixture was rapidly heated to 370° C. by raising temperature at a rate of about 200° C. per minute using radiant heat, and then reacted for several seconds while maintaining a temperature of 350° C. to 370° C. Thereafter, the second mixture was rapidly cooled to 100° C. or less within 1 minute to obtain second quantum dots having a ZnSeS shell formed on an InP core surface. It was confirmed that a maximum emission peak of the second quantum dots prepared as described above was 634 nm, a full width at half maximum thereof was 35 nm, and quantum efficiency was 96%.

(3) Manufacture of Quantum Dot Optical Film

UV curable acrylate oligomers (product name: DCT-Y01) 90 g, a first quantum dot solution 6 g (30 wt % in isobornyl acrylate; IBOA), a second quantum dot solution (30 wt % in IBOA) 2 g, a scattering agent TiO₂ dispersion solution (50 wt % in acrylate-based oligomers), and a light absorber dispersion solution having a main absorption wavelength of 590 nm (1 wt % in IBOA) were mixed to prepare a quantum dot composition. At this time, the light absorber dispersion solution was prepared by mixing 1 g of light absorbers with 99 g of IBOA, stirring it, and then, performing ultrasonic dispersion at 50° C. for 1 hour. In addition, a light absorber dispersion solution was added therein so that a concentration of the light absorbers in the quantum dot composition was 30 ppm. After forming the quantum dot composition thus prepared into a film on the substrate, it was cured by UV irradiation, so that a quantum dot optical film was prepared.

### Example 2

In Example 2, a quantum dot optical film was prepared in the same manner as in Example 1, except that a light absorber dispersion solution was added so that a concentration of light absorbers was 50 ppm when the quantum dot composition was prepared.

### Example 3

In Example 3, a quantum dot optical film was prepared in the same manner as in Example 1, except that a light absorber dispersion solution was added so that a concentration of light absorbers was 80 ppm when the quantum dot composition was prepared.

### Reference Example 1

In Reference Example 1, a quantum dot optical film was prepared in the same manner as in Example 1, except that a light absorber dispersion solution was added so that a concentration of light absorbers was 10 ppm when the quantum dot composition was prepared.

### Reference Example 2

In Reference Example 2, a quantum dot optical film was prepared in the same manner as in Example 1, except that a light absorber dispersion solution was added so that a concentration of light absorbers was 20 ppm when the quantum dot composition was prepared.

### Reference Example 3

In Reference Example 3, a quantum dot optical film was prepared in the same manner as in Example 1, except that a light absorber dispersion solution was added so that a concentration of light absorbers was 100 ppm when the quantum dot composition was prepared.

### Reference Example 4

In Reference Example 4, a quantum dot optical film was prepared in the same manner as in Example 2, except that a light absorber dispersion solution (1 wt % in IBOA) having a main absorption wavelength of 580 nm was used when the quantum dot composition was prepared.

### Reference Example 5

In Reference Example 5, a quantum dot optical film was prepared in the same manner as in Example 2, except that a light absorber dispersion solution (1 wt % in IBOA) having a main absorption wavelength of 570 nm was used when the quantum dot composition was prepared.

### Comparative Example 1

In Comparative Example 1, a quantum dot optical film was prepared in the same manner as in Example 1, except that a light absorber dispersion solution was not added when the quantum dot composition was prepared.

### Comparative Example 2

In Comparative Example 2, a quantum dot optical film was prepared in the same manner as in Example 1, except that a light absorber dispersion solution was added so that a concentration of light absorbers was 120 ppm when the quantum dot composition was prepared.

### Experimental Example 1

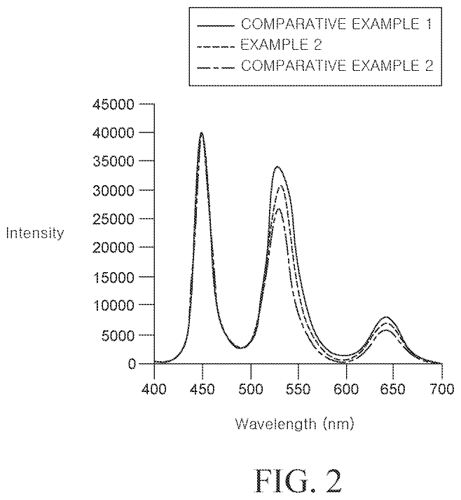

Maximum emission peaks (PLmax), full widths at half maximum (FWHM), luminance, and color reproducibility of the quantum dot optical films according to Examples 1 to 3, Reference Examples 1 to 3, and Comparative Examples 1 to 2 were measured. Consequent results are shown in Table 1 and FIG. 2 below.

FIG. 2 show emission spectra of quantum dot optical films according to Example 2, Comparative Example 1, and Comparative Example 2 of the present disclosure.

TABLE 1

| | | Comparative | Reference | Reference | | | | Reference | Comparative |
|---|---|---|---|---|---|---|---|---|---|
| | | Example 1 | Example 1 | Example 2 | Example 1 | Example 2 | Example 3 | Example 3 | Example 2 |
| Light Absorber | | 0 | 10 | 20 | 30 | 50 | 80 | 100 | 120 |
| Concentration(ppm) | | | | | | | | | |
| First | PLmax(nm) | 531.2 | 530.7 | 530.5 | 529.5 | 529.5 | 528.8 | 528.8 | 528.5 |
| Quantum | FWHM(nm) | 35 | 33.9 | 33.4 | 31.9 | 30.6 | 29.9 | 29.5 | 29.0 |
| Dots | | | | | | | | | |
| (518 nm) | | | | | | | | | |
| Second | PLmax(nm) | 640.9 | 640.6 | 640.6 | 640.6 | 640.6 | 640.6 | 640.6 | 640.6 |
| Quantum | FWHM(nm) | 37.2 | 37.2 | 36.8 | 36.6 | 36.0 | 36.0 | 36.0 | 36.0 |
| Dots | | | | | | | | | |
| (634 nm) | | | | | | | | | |

| | | | | | | | | |
|---|---|---|---|---|---|---|---|---|
| Relative Luminance (%) | 100 | 98 | 95 | 91 | 88 | 84 | 80 | 76 |
| Color | 85.2 | 88.1 | 89.2 | 91.4 | 93.2 | 93.6 | 93.9 | 94.1 |
| Reproducibility | | | | | | | | |
| (BT2020@CIE1976) (%) | | | | | | | | |

Referring to Table 1 and FIG. 2 together, in Examples 1, 2, and 3 where the light absorbers are included at concentrations of 30 ppm, 50 ppm, and 80 ppm, respectively, it can be confirmed that full widths at half maximum (FWHM) of a green emission wavelength and a red emission wavelength are narrow and high luminance is maintained, and at the same time, a color reproducibility is 90% or more, which was excellent.

Unlike this, it can be confirmed that in Comparative Example 1, which does not contain a light absorber, a full width at half maximum (FWHM) of the green emission wavelength and the red emission wavelength is wide, and color reproducibility decreases compared to the Examples. Meanwhile, in the case of Comparative Example 2 including light absorbers at a concentration of 120 ppm, it can be confirmed that luminance is reduced by about 8% to 15% compared to Examples 1 to 3.

Meanwhile, it can be confirmed that Reference Examples 1 and 2 including light absorbers at concentrations of 10 ppm and 20 ppm have improved color reproducibility compared to Comparative Example 1, but a degree of improvement thereof is insufficient, and in the case of Reference Example 3 including light absorbers at 100 ppm, it can be confirmed that luminance is lower than that of the Examples.

### Experimental Example 2

Maximum emission peaks (PLmax), full widths at half maximum (FWHM), luminance, and color reproducibility of the quantum dot optical films according to Example 2, Reference Example 4, and Reference Example 5 were measured. Consequent results are shown in Table 2 below.

TABLE 2

| | | Example | Reference | Reference |
|---|---|---|---|---|
| | | 2 | Example 4 | Example 5 |
| Main Absorption | | 590 | 580 | 570 |
| Wavelength of Light | | | | |
| Absorber (nm) | | | | |
| First | PLmax (nm) | 529.5 | 527.3 | 524.1 |
| Quantum Dots | FWHM (nm) | 30.6 | 28.9 | 27.8 |
| (518 nm) | | | | |
| Second | PLmax (nm) | 640.6 | 640.9 | 640.9 |
| Quantum Dots | FWHM (nm) | 36.0 | 37.1 | 37.2 |
| (634 nm) | | | | |

| | | | |
|---|---|---|---|
| Relative Luminance (%) | 88 | 72 | 58 |
| Color | 93.2 | 93.3 | 93.6 |
| Reproducibility (BT2020@ | | | |
| CIE1976) (%) | | | |

Referring to Table 2, compared to Comparative Example 1 without using the light absorber described above, it can be confirmed that in Reference Example 5 including light absorbers having a main absorption wavelength of 570 nm and Reference Example 4 including light absorbers having a main absorption wavelength of 580 nm, color reproducibility is improved to the same extent as Example 2 including light absorbers having a main absorption wavelength of 590 nm. However, in the case of Example 2 including light absorbers having a main absorption wavelength of 590 nm, it can be confirmed that color reproducibility can be improved while maintaining high luminance compared to Reference Examples 4 and 5.

To find out how optical properties change according to wavelengths of the first quantum dots and/or the second quantum dots included in the quantum dot optical film, experiments were conducted as follows.

### Experimental Example 3

In preparing quantum dot optical films, the quantum dot optical films were prepared in the same manner as in Experimental Example 1, except for using quantum dots having a wavelength of 629 nm instead of quantum dots having a wavelength of 634 nm as second quantum dots. Then, maximum emission peaks (PLmax), full widths at half maximum (FWHM), luminance, and color reproducibility of the respective quantum dot optical films were measured. Consequent results are shown in Table 3 below.

TABLE 3

| | | Reference Examples | | | | | | | |
|---|---|---|---|---|---|---|---|---|---|
| | | A1 | A2 | A3 | A4 | A5 | A6 | A7 | A8 |
| Light Absorber | | 0 | 10 | 20 | 30 | 50 | 80 | 100 | 120 |
| Concentration(ppm) | | | | | | | | | |
| First | PLmax(nm) | 531.2 | 530.7 | 530.5 | 529.5 | 529.5 | 528.8 | 528.8 | 528.5 |
| Quantum | FWHM(nm) | 35 | 33.9 | 33.4 | 31.9 | 30.6 | 29.9 | 29.5 | 29.0 |
| Dots | | | | | | | | | |
| (518 nm) | | | | | | | | | |
| Second | PLmax(nm) | 636.9 | 636.6 | 636.6 | 636.6 | 636.6 | 636.6 | 636.6 | 636.6 |
| Quantum | FWHM(nm) | 36.4 | 36.3 | 36.0 | 35.9 | 35.3 | 35.1 | 35.0 | 35.0 |
| Dots | | | | | | | | | |
| (629 nm) | | | | | | | | | |

| | | | | | | | | |
|---|---|---|---|---|---|---|---|---|
| Relative Luminance (%) | 100 | 95 | 92 | 88 | 84 | 80 | 74 | 69 |
| Color | 83.4 | 85.9 | 87.2 | 88.7 | 89.1 | 89.7 | 90.3 | 90.6 |
| Reproducibility | | | | | | | | |
| (BT2020@CIE1976) (%) | | | | | | | | |

Referring to Table 3, when light absorbers having a main absorption wavelength of 590 nm is included, it can be confirmed that color reproducibility is improved compared to an optical film not including the light absorber. In particular, when compared to Reference Example A1, Reference Examples A2, A3, A4, A5, and A6 including light absorbers at concentrations of 10 ppm, 20 ppm, 30 ppm, 50 ppm, and 80 ppm had significantly improved color reproducibility while maintaining high luminance.

Meanwhile, referring to Table 3 and Table 1 together, it can be confirmed that when using quantum dots having a wavelength of 634 nm as the second quantum dots, the relative luminance is maintained higher compared to the case of using quantum dots having a wavelength of 629 nm as the second quantum dots. In addition, as described in Experimental Example 1, in the case of Examples 1 to 3 using quantum dots having a wavelength of 634 nm as the second quantum dots, color reproducibility of 90% or more, which is very high, can be achieved while maintaining higher luminance within a range where light absorbers have a concentration of 30 to 80 ppm, From this, it can be confirmed that when this is applied to a display requiring high luminance and high color reproducibility, it is more preferable to use quantum dots having a wavelength of 630 nm or more as the second quantum dots.

### Experimental Example 4

When preparing quantum dot optical films, the quantum dot optical films were prepared in the same manner as in Experimental Example 1, except for using quantum dots having a wavelength of 525 nm instead of quantum dots having a wavelength of 518 nm as the first quantum dots. Then, maximum emission peaks (PLmax), full widths at half maximum (FWHM), luminance, and color reproducibility of the respective quantum dot optical films were measured. Consequent results are shown in Table 4 below.

TABLE 4

| | | Reference Examples | | | | | | | |
|---|---|---|---|---|---|---|---|---|---|
| | | B1 | B2 | B3 | B4 | B5 | B6 | B7 | B8 |
| Light Absorber | | 0 | 10 | 20 | 30 | 50 | 80 | 100 | 120 |
| Concentration(ppm) | | | | | | | | | |
| First | PLmax(nm) | 537.2 | 536.7 | 536.5 | 535.5 | 535.5 | 534.8 | 534.8 | 534.5 |
| Quantum | FWHM(nm) | 34 | 33.4 | 33.0 | 31.5 | 30.1 | 29.6 | 29.2 | 28.7 |
| Dots | | | | | | | | | |
| (525 nm) | | | | | | | | | |
| Second | PLmax(nm) | 640.9 | 640.6 | 640.6 | 640.6 | 640.6 | 640.6 | 640.6 | 640.6 |
| Quantum | FWHM(nm) | 37.2 | 37.2 | 36.8 | 36.6 | 36.0 | 36.0 | 36.0 | 36.0 |
| Dots | | | | | | | | | |
| (634 nm) | | | | | | | | | |

| | | | | | | | | |
|---|---|---|---|---|---|---|---|---|
| Relative Luminance (%) | 100 | 94 | 91 | 86 | 82 | 76 | 71 | 67 |
| Color | 83.1 | 85.2 | 86.8 | 87.9 | 88.5 | 88.9 | 89.3 | 89.5 |
| Reproducibility | | | | | | | | |
| (BT2020@CIE1976) (%) | | | | | | | | |

Referring to Table 4, when light absorbers having a main absorption wavelength of 590 nm is included (B1 to B8), it can be confirmed that color reproducibility is improved compared to a quantum dot optical film B1 without the light absorber. In particular, it can be confirmed that Reference Examples B4, B5, and B6 where light absorbers are included at 30 ppm, 50 ppm, and 80 ppm, respectively, have greatly improved color reproducibility while maintaining high luminance compared to Reference Example B1.

Meanwhile, referring to Table 4 and Table 1 together, it can be confirmed that when using quantum dots having a wavelength of 518 nm as the first quantum dots, the relative luminance is maintained higher compared to the case of using quantum dots having a wavelength of 525 nm as the first quantum dots. In addition, as seen in Experimental Example 1, in the case of Examples 1 to 3 using quantum dots having a wavelength of 518 nm as first quantum dots, it can be seen that higher luminance is maintained while a very high level of color reproducibility can be achieved with a color reproducibility of 90% or more, compared to Reference Examples B4, B5, and B6 where other conditions thereof except for the wavelength of the first quantum dots are identical to those of Examples 1 to 3. From this, it can be confirmed that when this is applied to a display requiring high luminance and high color reproducibility, it is more preferable to use quantum dots having a wavelength of 520 nm or less as the first quantum dots.

### Experimental Example 5

When preparing quantum dot optical films, the quantum dot optical films were prepared in the same manner as in Experimental Example 1, except for using quantum dots having a wavelength of 525 nm instead of quantum dots having a wavelength of 518 nm as the first quantum dots and using quantum dots having a wavelength of 629 nm instead of quantum dots having a wavelength of 634 nm as the second quantum dots. Then, maximum emission peaks (PLmax), full widths at half maximum (FWHM), luminance, and color reproducibility of the respective quantum dot optical films were measured. Consequent results are shown in Table 5 below.

TABLE 5

| | | Reference Examples | | | | | | | |
|---|---|---|---|---|---|---|---|---|---|
| | | C1 | C2 | C3 | C4 | C5 | C6 | C7 | C8 |
| Light Absorber | | 10 | 10 | 20 | 30 | 50 | 80 | 100 | 120 |
| Concentration(ppm) | | | | | | | | | |
| First | PLmax(nm) | 537.2 | 536.7 | 536.5 | 535.5 | 535.5 | 534.8 | 534.8 | 534.5 |
| Quantum | FWHM(nm) | 34 | 33.4 | 33.0 | 31.5 | 30.1 | 29.6 | 29.2 | 28.7 |
| Dots | | | | | | | | | |
| (525 nm) | | | | | | | | | |
| Second | PLmax(nm) | 636.9 | 636.6 | 636.6 | 636.6 | 636.6 | 636.6 | 636.6 | 636.6 |
| Quantum | FWHM(nm) | 36.4 | 36.3 | 36.0 | 35.9 | 35.3 | 35.1 | 35.0 | 35.0 |
| Dots | | | | | | | | | |
| (629 nm) | | | | | | | | | |

| | | | | | | | | |
|---|---|---|---|---|---|---|---|---|
| Relative Luminance (%) | 100 | 93 | 90 | 85 | 80 | 73 | 68 | 65 |
| Color | 82.7 | 84.6 | 86.3 | 87.1 | 87.9 | 88.1 | 88.3 | 88.4 |
| Reproducibility | | | | | | | | |
| (BT2020@CIE1976) (%) | | | | | | | | |

Referring to Table 5, when light absorbers having a main absorption wavelength of 590 nm is included (C1 to C8), it can be confirmed that color reproducibility is improved compared to the quantum dot optical film C1 without the light absorber. In particular, when compared to Reference Example C1, Reference Examples C4 and C5 where the light absorbers are included at 30 ppm and 50 ppm, respectively, have significantly improved color reproducibility while maintaining high luminance.

Meanwhile, referring to Table 5 and Table 1 together, in the cases of using quantum dots having a wavelength of 518 nm as the first quantum dots and using quantum dots having a wavelength of 634 nm as the second quantum dots, it can be confirmed that color reproducibility can be improved while maintaining higher luminance when light absorbers are added, compared to the case of using quantum dots having a wavelength of 629 nm as the second quantum dots. In particular, as described in Examples 1 to 3 of Experimental Example 1, color reproducibility of 90% or more, which is very high, can be achieved while maintaining high luminance within a range where light absorbers have a concentration of 30 to 80 ppm. From this, when this is applied to a display requiring high luminance and high color reproducibility, it can be confirmed that it is preferable to use quantum dots having a wavelength of 520 nm or less as the first quantum dots and use quantum dots having a wavelength of 630 nm or more as the second quantum dots while using light absorbers within a specific range.

The exemplary embodiments of the present disclosure can also be described as follows:

According to an aspect of the present disclosure, a quantum dot composition comprises a first quantum dot and a second quantum dot having different maximum emission wavelengths, a light absorber having a main absorption wavelength of 570 nm to 600 nm, and an oligomer.

The maximum emission wavelength of the first quantum dot may be 500 nm to 540 nm, and the maximum emission wavelength of the second quantum dot may be 610 nm to 650 nm.

The light absorber may be a dye having a main absorption wavelength of 580 nm to 590 nm.

The oligomer may be an acrylate-based oligomer.

The quantum dot composition may further comprise one or more scattering agents selected from among TiO₂, ZnO, ZrO₂, SiO₂ and BaSO₄.

The light absorber may be included in a concentration of 30 ppm to 80 ppm in the quantum dot composition.

The quantum dot composition may further comprise an acrylate-based monomer.

The acrylate-based monomer may be isobornyl (meth)acrylate.

Each of the first quantum dot and the second quantum dot may include one or more first metals selected from among Cd, Zn, In, Mg, Mn, Cu, Ga, Al, Sr, Ba, Fe, and Sn, and two or more second metals selected from among Se, S, P, Te, As, N, and Sb.

The first quantum dot may include a core composed of In—Zn—P and a shell composed of Zn—Se—S, and the second quantum dot may include a core composed of In—P and a shell of Zn—Se—S.

The core of the first quantum dot may be form by heating a first cation precursor including an indium oxo cluster (In-Oxocluster) and a zinc oxo cluster (Zn-Oxocluster) and a first anion precursor including phosphorus (P) to a high temperature of 300° C. to 350° C., and the shell of the first quantum dot may be form by heating the core of the first quantum dot, a second cation precursor including zinc oleate, and a second anion precursor including trioctylphosphine selenide and trioctylphosphine sulfide to a temperature of 350° C. to 400° C. at a high rate.

The core of the second quantum dot may be form by heating a first cation precursor including indium oxo clusters (In-Oxocluster) and a first anion precursor including phosphorus (P) to a high temperature of 300° C. to 350° C., and the shell of the second quantum dot is formed by heating the core of the second quantum dot, a second cation precursor including zinc oleate, and a second anion precursor including trioctylphosphine selenide and trioctylphosphine sulfide to a temperature of 350° C. to 400° C. at a high rate.

The zinc oleate may be form by reacting zinc and oleic acid in a molar ratio of 1:1.3 to 1:1.7, and a molar ratio of the trioctylphosphine selenide to trioctylphosphine sulfide may be 0.8:1 to 1:2.5.

According to another aspect of the present disclosure, a quantum dot film comprises a cured product of the quantum dot composition comprising a first quantum dot and a second quantum dot having different maximum emission wavelengths, a light absorber having a main absorption wavelength of 570 nm to 600 nm, and an oligomer.

According to another aspect of the present disclosure, a display device comprises a backlight unit, a quantum dot optical film disposed on the backlight unit and including a first quantum dot and a second quantum dot having different maximum emission wavelengths, a light absorber having a main absorption wavelength of 570 nm to 600 nm, and a resin, and a display panel disposed on the quantum dot optical film.

The resin may include a cured product of an acrylate-based oligomer and an acrylate-based monomer.

A maximum emission wavelength of the first quantum dot may be 500 nm to 540 nm, and a maximum emission wavelength of the second quantum dot may be 610 nm to 650 nm.

The first quantum dot may include a core composed of In—Zn—P and a shell composed of Zn—Se—S, and the second quantum dot may include a core composed of In—P and a shell of Zn—Se—S.

A concentration of the light absorber included in the quantum dot optical film may be 30 ppm to 80 ppm.

Although the exemplary embodiments of the present disclosure have been described in detail with reference to the accompanying drawings, the present disclosure is not limited thereto and may be embodied in many different forms without departing from the technical concept of the present disclosure. Therefore, the exemplary embodiments of the present disclosure are provided for illustrative purposes only but not intended to limit the technical concept of the present disclosure. The scope of the technical concept of the present disclosure is not limited thereto. Therefore, it should be understood that the above-described exemplary embodiments are illustrative in all aspects and do not limit the present disclosure. The protective scope of the present disclosure should be construed based on the following claims, and all the technical concepts in the equivalent scope thereof should be construed as falling within the scope of the present disclosure.

What is claimed is:

1. A quantum dot composition, comprising:
a first quantum dot and a second quantum dot, the first quantum dot and the second quantum dot having different maximum emission wavelengths;
a light absorber having a main absorption wavelength of 570 nm to 600 nm; and
an oligomer.

2. The quantum dot composition of claim 1, wherein the maximum emission wavelength of the first quantum dot is 500 nm to 540 nm, and the maximum emission wavelength of the second quantum dot is 610 nm to 650 nm.

3. The quantum dot composition of claim 1, wherein the light absorber is a dye having a main absorption wavelength of 580 nm to 590 nm.

4. The quantum dot composition of claim 1, wherein the oligomer is an acrylate-based oligomer.

5. The quantum dot composition of claim 1, further comprising:
One or more scattering agents selected from among TiO₂, ZnO, ZrO₂, SiO₂, and BaSO₄.

6. The quantum dot composition of claim 1, wherein the light absorber is included in a concentration of 30 ppm to 80 ppm in the quantum dot composition.

7. The quantum dot composition of claim 1, further comprising:
an acrylate-based monomer.

8. The quantum dot composition of claim 7, wherein the acrylate-based monomer is isobornyl (meth)acrylate.

9. The quantum dot composition of claim 1, wherein each of the first quantum dot and the second quantum dot includes one or more first metals selected from among Cd, Zn, In, Mg, Mn, Cu, Ga, A1, Sr, Ba, Fe, and Sn, and two or more second metals selected from among Se, S, P, Te, As, N, and Sb.

10. The quantum dot composition of claim 1, wherein the first quantum dot includes a core composed of In—Zn—P and a shell composed of Zn—Se—S, and the second quantum dot includes a core composed of In—P and a shell of Zn—Se—S.

11. The quantum dot composition of claim 10, wherein the core of the first quantum dot is formed by heating a first cation precursor including an indium oxo cluster (In-Oxocluster) and a zinc oxo cluster (Zn-Oxocluster) and a first anion precursor including phosphorus (P) to a high temperature of 300° C. to 350° C., and
the shell of the first quantum dot is formed by heating the core of the first quantum dot, a second cation precursor including zinc oleate, and a second anion precursor including trioctylphosphine selenide and trioctylphosphine sulfide to a temperature of 350° C. to 400° C. at a high rate.

12. The quantum dot composition of claim 10, wherein the core of the second quantum dot is formed by heating a first cation precursor including indium oxo clusters (In-Oxocluster) and a first anion precursor including phosphorus (P) to a high temperature of 300° C. to 350° C., and
the shell of the second quantum dot is formed by heating the core of the second quantum dot, a second cation precursor including zinc oleate, and a second anion precursor including trioctylphosphine selenide and trioctylphosphine sulfide to a temperature of 350° C. to 400° C. at a high rate.

13. The quantum dot composition of claim 11, wherein the zinc oleate is formed by reacting zinc and oleic acid in a molar ratio of 1:1.3 to 1:1.7, and a molar ratio of the trioctylphosphine selenide to trioctylphosphine sulfide is 0.8:1 to 1:2.5.

14. A quantum dot film comprising a cured product of the quantum dot composition according to claim 1.

15. A display device comprising:
a backlight unit;
a quantum dot optical film disposed on the backlight unit and including a first quantum dot and a second quantum dot, the first quantum dot and the second quantum dot having different maximum emission wavelengths, a light absorber having a main absorption wavelength of 570 nm to 600 nm, and a resin; and
a display panel disposed on the quantum dot optical film.

16. The display device of claim 15, wherein the resin includes a cured product of an acrylate-based oligomer and an acrylate-based monomer.

17. The display device of claim 15, wherein a maximum emission wavelength of the first quantum dot is 500 nm to 540 nm, and a maximum emission wavelength of the second quantum dot is 610 nm to 650 nm.

18. The display device of claim 15, wherein the first quantum dot includes a core composed of In—Zn—P and a shell composed of Zn—Se—S, and the second quantum dot includes a core composed of In—P and a shell of Zn—Se—S.

19. The display device of claim 15, wherein a concentration of the light absorber included in the quantum dot optical film is 30 ppm to 80 ppm.
